(19) United States
(12) Patent Application Publication
(10) Pub. No.: US 2012/0262829 A1
(43) Pub. Date: Oct. 18, 2012

(54) PROTECTION DEVICE AGAINST ELECTROMAGNETIC INTERFERENCE

(75) Inventor: Christian Spratler, Buehlertal (DE)

(73) Assignee: ROBERT BOSCH GMBH, Stuttgart (DE)

(21) Appl. No.: 13/502,164

(22) PCT Filed: Oct. 11, 2010
(86) PCT No.: PCT/EP2010/065173

§ 371 Date: Jun. 27, 2012

(30) Foreign Application Priority Data
Oct. 14, 2009 (DE) 10 2009 045 684.8

(51) Int. Cl. H02H 9/00

(52) U.S. Cl. 361/56

(57) ABSTRACT

The invention relates to a protection device for reducing grid-bound interference, comprising a protection circuit as an input filter of an electronic circuit, wherein the electronic circuit is applied to a multilayer circuit board or is at least partially integrated therein, wherein individual components of the circuit are implemented as embedded structures in the multilayer circuit board. According to the invention, the protection circuit is formed by a cascade of at least as two capacitances coupled to each other by means of low-inductance circuit board structures, wherein the capacitances are implemented as embedded capacitor structures on or within the multilayer circuit board. By means of said protection device, improved filter behavior can be achieved relative to discretely populated protection filters, in particular at higher frequencies, leading to improved protection against electrostatic interference. The filter structure can further be adjusted very well in simulation to the required interference resistance of the circuit to be protected, and also achieve improved aging behavior.

### BACKGROUND OF THE INVENTION

The invention relates to a protection device for reducing line-conducted interference, comprising a protection circuit as an input filter of an electronic circuit, wherein the electronic circuit is applied on a multilayer printed circuit board or is at least partly integrated into the latter, wherein individual components of the circuit are embodied as embedded structures in the multilayer printed circuit board.

Line-conducted interference such as electrostatic discharges (ESD) for example, can couple into electronic assemblies and damage the latter. In order to protect these circuits, so-called blocking structures are used, which are usually constructed from discrete components.

Examples thereof are varistors, voltage-dependent resistors, or spark gaps which are arranged at the start of the coupling-in path of the circuit to be protected. They are generally expensive and in some instances have a large space requirement. Furthermore, SMD capacitors are also known, which are positioned at the input of the circuit to be protected and which dissipate a portion of the pulses coupling in to ground. The capacitance is dimensioned according to empirical values, although in practice this can often lead to a non-optimum design of the protective circuitry. Moreover, a certain degradation behavior is observed, i.e. a reduction of the capacitance as a result of repeated pulse loading and associated loss of the blocking capability. Besides this effect, a parasitic, series inductance can prevent the charge carriers coupling in with the pulse edge from rapidly flowing away, as a result of which the filter properties of the arrangement are impaired. Thus, in particular high-frequency components of the pulse can still penetrate into the circuit to be protected.

The published patent application US 2005/0162790 A1 describes, for example, an ESD protection device having an input terminal and an output terminal, between which diverse protection filters are arranged.

In the case of printed circuit boards (PCB), of multilayered construction, so-called embedded component structures have become known in the meantime, wherein the components are integrated on and within the printed circuit board. Inter alia, capacitor structures can be formed in embedded fashion. Some IEEE publications describe, inter alia, such embedded capacitor structures (e.g. “AC coupled backplane communication using embedded capacitor” Bruce Su et al., or “Power-Bus decoupling with embedded capacitance in printed circuit board design”, Minjia Xu et al.). U.S. Pat. No. 6,351,880 B1 describes, for example, a method for producing a capacitor element integrated in a substrate of multilayered construction.

### SUMMARY OF THE INVENTION

It is an object of the invention to provide a protection device with which improved protection in relation to line-conducted interference, in particular at relatively high frequencies, can be obtained and improved adaptation to the required interference immunity of the circuit to be protected can be achieved. Moreover, the abovementioned disadvantages in the case of conventional protective circuitries are intended to be avoided.

The invention provides for the protection circuit to be formed from a cascade of at least two capacitances which are coupled to one another by means of low-inductance conductor track structures, wherein the capacitances are formed as embedded capacitance structures on or within the multilayer printed circuit board. This arrangement is advantageous in relation to protective circuitries equipped in discrete fashion, since it is hereby possible to obtain a better filter quality factor particularly at relatively high frequencies, such that even high-frequency interference components beyond a frequency of 1 GHz can be blocked. Besides the dimensioning of the capacitances, this is possible, in particular, since a particularly low-inductance coupling can be achieved as a result of the embodiment of the capacitances as embedded components. A further advantage over conventional protective circuitries arises from the fact that no degradation is registered upon multiple pulse loading. Moreover, the embedding of such a blocking structure into the PCB allows an improved aging behavior to be expected by comparison with discrete population. Furthermore, it is thereby possible to realize compact circuits with a small structural height. This structure can be optimized and used for all possible forms of line-conducted interference.

In one possible embodiment, the protection circuit is formed from three cascaded capacitances, wherein the low-inductance conductor track structures each have a simulation-optimized line length. It is thus possible to obtain an optimum filter property in relation to a multiplicity of different interference pulse forms. A transfer frequency response is attained which proceeds distinctly below −10 dB above a cut-off frequency in the two-digit MHz range into the range of several GHz.

With regard to a compact structural size it is advantageous if the filter structure of the input filter is formed from an area-optimized arrangement composed of capacitive area elements and conductor tracks.

In order to be able to realize sufficiently large capacitance values in conjunction with a minimal space requirement, the capacitor structures embedded in the multilayer printed circuit board for the purpose of forming the capacitances, in terms of their layer construction, can be formed from a first and a second electrode, which are in each case arranged in a manner spaced apart by means of a dielectric and insulated with respect to a grounded conductor layer arranged between the electrodes.

The minimal space requirement to be striven for can be obtained, in particular, if the dielectric between the electrodes and the grounded conductor layer is formed from a material having high dielectric constants and high dielectric strength and in each case has a layer thickness of less than 150 μm. The use of such particularly thin layers makes possible comparatively large capacitance values. By way of example, ceramic-PTFE composite materials (e.g. Ro3010 from Rogers Corp.) having a relative permittivity εᵣ of about 10 and having very good material properties particularly in the RF range are suitable as the dielectric. Moreover, such a material has a good processability for producing printed circuit boards.

The dimensioning of the filter structure of the protection circuit is advantageously formed by means of a network model in which firstly an ideal transfer function is determined on the input side by means of a normalized interference source, for example an electrostatic discharge caused by humans (e.g. according to the human body model HBM), for a transfer path to an interference sink, in this case for example a MOS-FET circuit to be protected, on the output side and a next step involves determining an analytically estimated filter structure as a model from embedded capacitances by means of simulation. In this case, the cut-off data for a filter, e.g. the position of the cut-off frequency, are determined from the transfer function of an HMB pulse, for example.

A particularly area-optimized arrangement of the filter structure can be obtained if the dimensioning of the filter structure of the protection circuit is determined by a space-saving arrangement of the capacitance structures and using a plurality of layers and a small layer thickness.

This optimized arrangement can be modified depending on the material used and the interference immunity of the circuit to be protected relative to the overcoupled portions since the transfer function of the protection circuit is adaptable with regard to a cut-off frequency shift and/or a bandwidth adaptation by means of dimensional adaptation of the capacitance structures, wherein the dimensional adaptation can be carried out by means of a length and/or width adaptation of individual capacitors and/or by means of a scaling of the side length of the entire filter structure. A scaling of the side length of the filter structure to smaller side lengths brings about, for example, an increase in the cut-off frequency, and vice versa, wherein a reduction of the side length by the factor 2 corresponds approximately to a doubling of the cut-off frequency. By means of the length and/or width adaptations of individual capacitors, it is possible to vary specific bandpass filter sections in the transfer function. An optimum adaptation is thus possible in the individual case, which would not be possible for discrete population of a protection circuit on account of the component variation.

A preferred use of the protection device as described above provides for the use in a motor vehicle for reducing electrostatic interference and/or attenuating high-frequency interference components on sensor, control and/or data lines or on drivetrains in electric motor vehicles. In particular, on account of the increasing complex control tasks and on account of the introduction of bus systems, problems with electrostatic interference can occur which can be solved or at least significantly reduced with the use of the proposed protection device. Power electronics, in particular, can be designed more compactly with regard to the structural height and with higher interference immunity as a result of integration of protection circuits of this type.

### BRIEF DESCRIPTION OF THE DRAWINGS

The invention is explained in greater detail below on the basis of an exemplary embodiment illustrated in the figures, in which:

FIG. 1 shows a plan view of a protection device comprising capacitance and induction structures,

FIG. 2 shows a protection circuit corresponding to the protection device illustrated in FIG. 1,

FIG. 3 shows in schematic illustration, by way of example, the construction of a multilayer printed circuit board with an embedded capacitor,

FIG. 4 shows a transfer function of the protection device, and

FIG. 5 and FIG. 6 each show in schematic illustration the effect of dimensional adaptations of the protection device on the transfer function.

### DETAILED DESCRIPTION

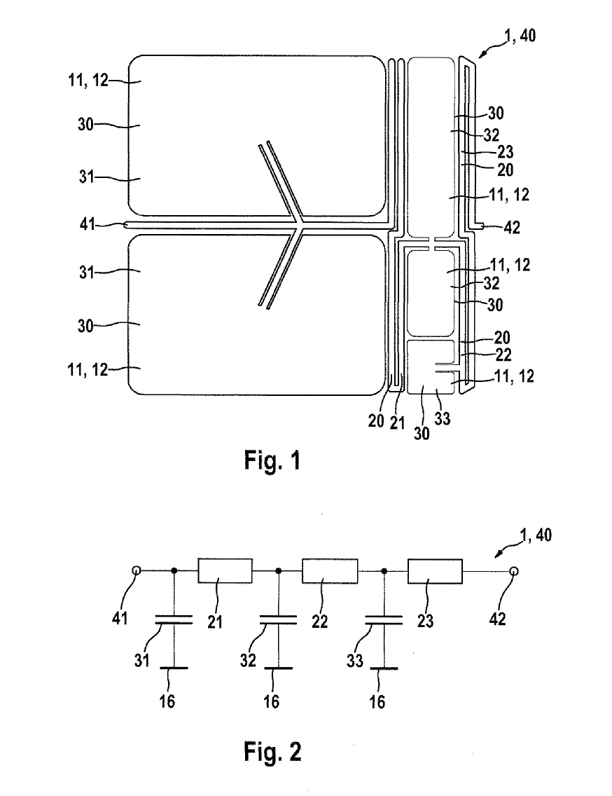

FIG. 1 illustrates a plan view of a protection device 1 comprising capacitance and induction structures 30, 20, which forms a protection circuit 40, wherein the capacitance structure 30 is illustrated according to the invention as an embedded component in a printed circuit board. In this view, therefore, only the electrodes 11, 12 of the capacitance structures 30 and the conductor tracks which couple the capacitance structures 30 to one another can be discerned. In this case, the conductor tracks form inductance structures 20. This illustration does not illustrate corresponding counterelectrodes or shielding arrangements and insulator or dielectric layers. These are situated as additional layers that are not visible below and/or above the layer shown.

In the example shown, a first capacitance 31 are illustrated, which is arranged downstream of the input 41 of the protection circuit 40 directly as viewed in the signal direction and assumes a comparatively large value in accordance with the area of the structure. In the example shown, this first capacitance 31 has two areas of identical size. This first capacitance 31 is coupled, via a conductor track meander embodied as first inductance 21, to a second capacitance 32, likewise embodied with two wings. The value of said capacitance 32, in accordance with the area of the electrodes 11, 12, is significantly lower than that of the first capacitance 31 in this filter network. The coupling of said second capacitance 32 to a third capacitance 33 is likewise effected via a conductor track structure, which forms the second inductance 22. Said third capacitance is likewise again made smaller, in accordance with the area of its electrodes 11, 12, than the second capacitance 32. A third inductance 23 in the form of a further conductor track meander is provided with respect to the output 42 of the protection circuit 40.

In this case, the layout of the protection device 1 or of the protection circuit 40 is designed in such a way that the low-inductance conductor track structures in each case have a simulation-optimized line length, wherein the filter structure of this input filter is formed from an area-optimized arrangement of the capacitive area elements and of the conductor tracks.

FIG. 2 shows, as an electrical equivalent circuit diagram, a protection circuit 40 corresponding to the protection device 1 illustrated in FIG. 1. Situated between the input 41 and the output 42 of the protection circuit 40 is a cascade of three capacitors (capacitances 31, 32, 33), which respectively have one electrode coupled to conductor tracks. The respective other electrodes of the three capacitors are at ground (grounding 16). The conductor tracks form the low-inductance inductances 21, 22, 23. The latter can be predetermined very precisely by the layout of the protection device 1.

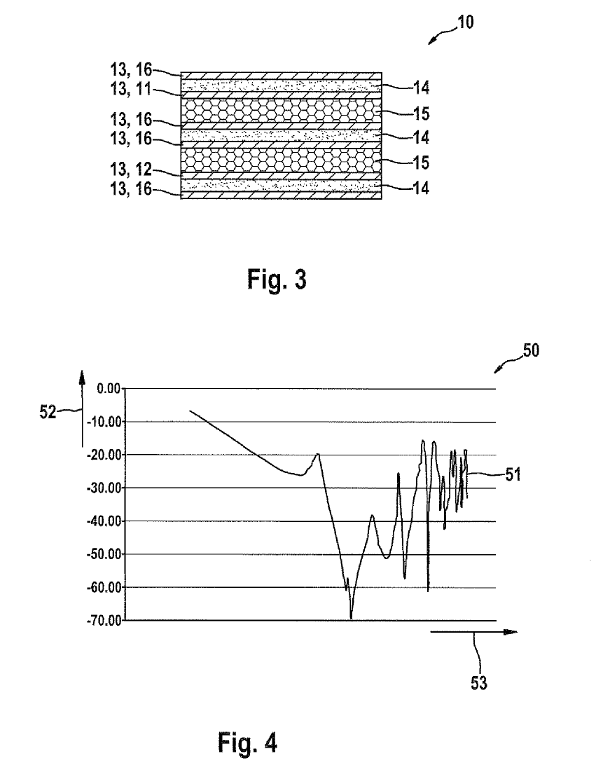

FIG. 3 illustrates by way of example in section a multilayer printed circuit board 10, in which a capacitor structure is embedded. In the layer sequence, starting from the top, the multilayer printed circuit board 10 firstly comprises an approximately 75 μm thick layer composed of FR4 carrier material 14, which has an approximately 35 μm thick copper layer 13 on both sides. The upper copper layer 13 is at ground (grounding 16). The lower copper layer forms the first electrode 11 of the capacitor structure. A further approximately 75 μm thick layer composed of FR4 carrier material 14 is situated in a manner insulated from said first electrode 11 by a dielectric composed of a ceramic-PTFE composite material 15 (e.g. Ro3010, 125 μm thick), said layer likewise having a copper layer 13 having a layer thickness of 35 μm on both sides. Both copper layers 13 are likewise connected to ground (grounding 16). Toward the bottom there again follows a dielectric layer composed of the ceramic-PTFE composite material 15, which insulates the copper layer 13 embodied as second electrode 12 from the grounded copper layer 13 in the center of the multilayer printed circuit board 10. The copper layer 13 embodied as second electrode 12 is part of a lower layer composed of FR4 carrier material 14, which likewise has a copper layer 13 having a layer thickness of 35 μm on both sides, the bottommost copper layer 13 in the layer construction again being connected to ground (grounding 16).

Small layer thicknesses, particularly in the case of the dielectric layers formed within the multilayer printed circuit board 10, and the use of a plurality of layers make possible a space-saving arrangement of the capacitance structures.

FIG. 4 shows by way of example in a profile diagram a transfer function 50 of the filter arrangement from FIG. 1 or of the protection circuit 40 from FIG. 2. The illustration shows a transfer frequency profile 51 illustrating an output signal strength 52 as a function of the frequency 53. The output signal strength 52 is specified in dB. The scaling of the frequency 53 is likewise illustrated logarithmically. The filter arrangement achieves a transfer frequency profile 51 which proceeds distinctly below −10 dB above a cut-off frequency of from approximately 20 MHz to the range of approximately 10 GHz, which provides for a broadband suppression of high-frequency interference pulses. In comparison with discretely constructed protection circuits 40, the quality factor of the filtering is significantly improved particularly in the case of frequency components at high frequency.

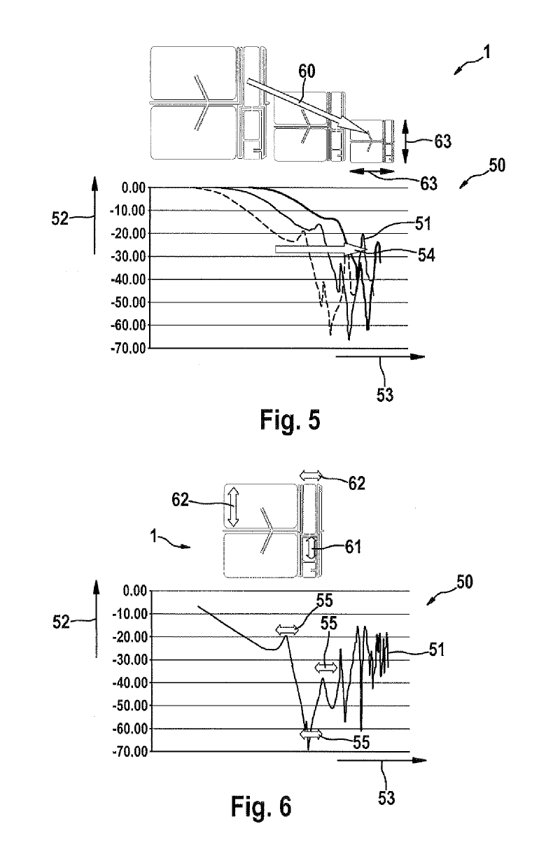

FIGS. 5 and 6 schematically show how the transfer function 50 of the protection device 1 as illustrated in FIG. 4 can be adapted by means of dimensional adaptation 60 of the capacitance structures with regard to a cut-off frequency shift 54 (FIG. 5) and/or a bandwidth adaptation 55 (FIG. 6). Thus, for example, by scaling the side length 63 of the entire filter structure, as is illustrated schematically in FIG. 5, it is possible to shift the cut-off frequency, wherein approximately a halving of the side length 63 of the entire filter structure brings about a cut-off frequency doubling. FIG. 6 schematically illustrates the fact that by means of a length and/or width adaptation 61, 62 of individual capacitor structures of the protection device 1 within the transfer function 50 it is possible to perform bandwidth adaptation 55 within individual frequency ranges.

1. A protection device (1) for reducing line-conducted interference, comprising a protection circuit (40) as an input filter of an electronic circuit, wherein individual components of the circuit are embodied as embedded structures in a multilayer printed circuit board (10), characterized in that the protection circuit (40) is formed from a cascade of at least two capacitances (31, 32, 33) which are coupled to one another by low-inductance conductor track structures, wherein the capacitances (31, 32, 33) are formed as embedded capacitance structures (30).

2. The protection device (1) as claimed in claim 1, characterized in that the protection circuit (40) is formed from three cascaded capacitances (31, 32, 33), wherein the low-inductance conductor track structures each have a simulation-optimized line length.

3. The protection device (1) as claimed in claim 1, characterized in that the filter structure of the input filter is formed from an area-optimized arrangement composed of capacitive area elements and conductor tracks.

4. The protection device (1) as claimed in claim 1, characterized in that the capacitor structures (30) embedded in the multilayer printed circuit board (10), are formed from a first and a second electrode (11, 12), which are in each case arranged in a manner spaced apart by means of a dielectric and insulated with respect to a grounded conductor layer arranged between the electrodes (11, 12).

5. The protection device (1) as claimed in claim 4, characterized in that the dielectric between the electrodes (11, 12) and the grounded conductor layer is formed from a material having high dielectric constants and high dielectric strength and in each case has a layer thickness of less than 150 μm.

6. The protection device (1) as claimed in claim 1, characterized in that the dimensioning of the filter structure of the protection circuit (40) is formed by means of a network model in which an ideal transfer function (50) is determined on the input side by means of a normalized interference source.

7. The protection device (1) as claimed in claim 6, characterized in that the dimensioning of the filter structure of the protection circuit (40) is determined by a space-saving arrangement of the capacitance structures and using a plurality of layers and a small layer thickness.

8. The protection device (1) as claimed in claim 6, characterized in that the transfer function (50) of the protection circuit (40) is adaptable by dimensional adaptation (60) of the capacitance structures (30).

9. The use of the protection device (1) as claimed in claim 1 in a motor vehicle for reducing interference of components in electric motor vehicles.

10. The protection device (1) as claimed in claim 1, characterized in that the electronic circuit is applied on the multilayer printed circuit board (10).

11. The protection device (1) as claimed in claim 1, characterized in that the electronic circuit is at least partially integrated into the multilayer printed circuit board (10).

12. The protection device (1) as claimed in claim 4, characterized in that the capacitor structures (30) form the capacitances (31, 32, 33).

13. The protection device (1) as claimed in claim 8, characterized in that the transfer function (50) of the protection circuit (40) is adaptable with regard to a cut-off frequency shift (54).

14. The protection device (1) as claimed in claim 8, characterized in that the transfer function (50) of the protection circuit (40) is adaptable with regard to a bandwidth adaptation (55).

15. The protection device (1) as claimed in claim 8, characterized in that the transfer function (50) of the protection circuit (40) is adaptable with regard to a cut-off frequency shift (54) and a bandwidth adaptation (55).

16. The protection device (1) as claimed in claim 8, characterized in that the dimensional adaptation (60) is a length adaptation (61) of the individual capacitors (31, 32, 33).

17. The protection device (1) as claimed in claim 8, characterized in that the dimensional adaptation (60) is a width adaptation (62) of the individual capacitors (31, 32, 33).

18. The protection device (1) as claimed in claim 8, characterized in that the dimensional adaptation (60) is a scaling of the side length (63) of the entire filter structure.

19. The protection device (1) as claimed in claim 9, characterized in that the interference reduction is reduction of electrostatic interference and/or attenuation of high-frequency interference.

20. The protection device (1) as claimed in claim 9, characterized in that the components are on sensor, control, and/or data lines or on drivetrains.
